(19) United States
(12) Patent Application Publication
(10) Pub. No.: US 2023/0236157 A1
(43) Pub. Date: Jul. 27, 2023

(54) Chromatography System

(71) Applicant: Alexander Bozic, Oberursel (DE)

(72) Inventor: Alexander Bozic, Oberursel (DE)

(21) Appl. No.: 18/098,932

(22) Filed: Jan. 19, 2023

(30) Foreign Application Priority Data
Jan. 24, 2022 (DE) 10 2022 101 546.7

(51) Int. Cl. G01N 30/20; G01N 30/32; G01N 30/34; B01F 25/40; B01D 15/14

(52) U.S. Cl. CPC G01N 30/20; G01N 30/32; G01N 30/34; B01F 25/40; B01D 15/14; G01N 2030/385

(57) ABSTRACT

A chromatography system comprising at least two pumps, a first pump which is connectable or connected with a liquid reservoir for a first fluid, and a second pump which is connectable or connected with a liquid reservoir for a second fluid, wherein the pump outlet lines from the first pump and the second pump are connected with a connection piece and, viewed in the direction of flow, a chromatography column is provided downstream of this connection piece, wherein, viewed in the direction of flow, an addition unit is provided upstream of the connection piece and a mixer switching valve and a mixer switchable by way of the mixer switching valve are provided between the connection piece and chromatography column, wherein the mixer switching valve has at least two switching positions, wherein the mixer is connectable in a first position and the mixer is bypassable in a second position.

A chromatography method in which the system is used and a conversion kit for converting a high-performance liquid chromatography system into a chromatography system for supercritical fluid chromatography are also disclosed.

The present invention relates to a chromatography system and to a chromatography method.

Chromatographic techniques are important tools for identifying and separating complex samples. The basic principle underlying chromatographic techniques involves separating a mixture into individual components by conveying the mixture in a moving fluid through a retentive medium. The moving fluid is typically denoted the mobile phase and the retentive medium typically the stationary phase. Separation of the various constituents of the mixtures is based on a differing distribution between the mobile and stationary phases. Differences in the distribution coefficients of the components lead to differing retention on the stationary phase, thereby leading to separation.

Advanced and now well established chromatography methods include, inter alia, high-performance liquid chromatography (HPLC) and supercritical fluid chromatography (SFC).

In all techniques, but in particular for HPLC and SFC, appropriate application of the sample onto the chromatography column is an essential step if good and reliable separation is to be effected.

In HPLC, a sample to be investigated must be fed into a high-pressure stream of fluid, wherein this may only be interrupted for as short a time as possible. High-pressure injection valves, which permit a virtually uninterrupted changeover of the stream of fluid, are used for this purpose. This problem is explained in detail in, for example, document DE10 2008 006 266 A1 and the publications cited therein.

Through supercritical fluid chromatography (SFC) many advantages can be achieved, such that different substances can be particularly easily and reliably separated, chemically analyzed, identified and quantified. If carbon dioxide (CO₂) is used as a fluid in SFC applications, the extraction of the substances is generally carried out above the critical temperature of 31° C. and above a critical pressure of 74 bar.

To keep CO₂ or a CO₂ mixture in a liquid state within a chromatography column, the entire chromatography system must be kept at a predetermined pressure level. For this purpose, a backpressure regulator is typically provided downstream of the chromatography column and downstream of a respective detector, to keep the pressure within the chromatography system at a predetermined level.

This is, however, associated with problems for sample introduction. These are explained in detail in, for example, documents U.S. Pat. No. 6,428,702 B1 and U.S. Pat. No. 6,576,125 B2.

The known HPLC and SFC methods have long been used for both analytical and preparative purposes, corresponding systems being commercially obtainable. Efforts are, however, generally being made to improve the characteristics of these systems and methods.

Accordingly, there is in particular interest in increasing the purity of the separated or purified substances. Furthermore, losses of substances to be separated or purified arising due to purification should be kept as low as possible. Furthermore, the chromatography system or chromatography method should be capable of processing successive, possibly unrelated samples as quickly as possible and without contamination by earlier samples within a short period of time.

In the light of the prior art, it is therefore an object of the present invention to provide a chromatography system which solves the problems set out above. In particular, the system should lead to particularly pure products obtained in high yield. The system should furthermore have a high throughput, wherein various samples can be applied and purified in rapid succession without requiring elaborate purification cycles.

Furthermore, substances to be separated should be able to have the smallest possible run time difference without this resulting in the separation thereof in the system becoming ineffective. Furthermore, for a given run time difference, the system should effect the highest possible batch separation. In particular, the chromatography system should effect excellent separation, such that detection provides very clear signals for the substances to be separated.

A further object consists of providing a chromatography system which can be operated and produced particularly inexpensively while requiring little maintenance.

The system should be as simply and inexpensively operable as possible and lead to further advantages in cost and handling.

Furthermore, relative to its volumetric flow rate, the chromatography system should be as reasonably priced as possible.

A further object of the invention is to provide a method for carrying out a chromatographic procedure in which the highest possible yield of purified substances can be achieved. The separated substances should here be of the highest possible purity. The system should furthermore be as simply and inexpensively performable as possible and lead to further cost and handling advantages.

Furthermore, a high yield and purity of the substances to be separated should be achievable for the widest possible variety of liquid mixtures or gas-liquid mixtures.

Further, it is an object of the present invention to provide components enabling a known HPLC system to be converted into an SFC system as easily as possible. Conversion of preparative HPLC systems should also be made possible.

These and further objects which are not explicitly mentioned, but can easily be derived or inferred from the interrelationships discussed in the introduction, are achieved by a chromatography system having all the features of claim 1.

The present invention accordingly provides a chromatography system comprising at least two pumps, a first pump which is connectable or connected with a liquid reservoir for a first fluid, and a second pump which is connectable or connected with a liquid reservoir for a second fluid, wherein the pump outlet lines from the first pump and the second pump are connected with a connection piece and, viewed in the direction of flow, a chromatography column is provided downstream of this connection piece,

which is characterized in that,

viewed in the direction of flow, an addition unit is provided upstream of the connection piece, and a mixer switching valve and a mixer switchable by way of the mixer switching valve are provided between the connection piece and chromatography column, wherein the mixer switching valve has at least two switching positions, wherein the mixer is connectable in a first position and the mixer is bypassable in a second position.

The present invention in particular ensures that particularly pure products are obtained in high yield. The system furthermore has a high throughput, wherein various samples can be applied and purified in rapid succession without requiring elaborate cycles for purification and/or equilibration of the chromatography column. In particular, cycle reproducibility for the purification and/or separation of sample compositions is greatly increased, such that peaks can be predicted with improved accuracy.

In particular, in comparison with other chromatography systems, an improvement is achieved to the effect that, for a given run time difference, very high batch separation can be effected by the chromatography system. Furthermore, very good separation can be effected in the chromatography system in the case of a relatively small run time difference of the substances to be separated. In particular, very narrow signals of the substances to be separated are obtained on detection.

Even pumps of very simple construction may here be used, meaning that further capital cost advantages are achieved.

Furthermore, very good results are also achieved in chromatography methods in which the system is operated with a gradient. Additionally, an SFC method can also be carried out at very different volumetric flow rates of the aerosol without the economic advantages being too severely impaired.

Further, the present method and the chromatography system for carrying out a method can reduce the complexity and cost of technical equipment required for setting up the SFC analysis. Here, HPLC systems that are intended for preparative use can also be converted.

The chromatography system according to the invention comprises at least two pumps, a first pump and a second pump. The nature of the pumps is immaterial for purposes of the present invention. Rotary piston pumps, centrifugal pumps, gear pumps and reciprocating pumps can accordingly be used. The invention does, however, permit the use of inexpensive reciprocating pumps which can preferably comprise at least two pistons. In reciprocating pumps with at least two pistons, the two pistons can be controlled by way of a camshaft. The two pistons can furthermore be mutually independently controlled, wherein control by way of a camshaft is much more inexpensive and can be used for the purposes of the present invention. The first pump and/or the second pump is preferably configured as a reciprocating pump, wherein the pump head is preferably coolable. Pump head coolability is in particular expedient in a chromatography system which is configured as an SFC system.

The present invention particularly surprisingly means that excellent separation efficiencies are achievable even with inexpensive pumps.

The first pump is connectable or connected with a liquid reservoir for a first fluid, and a second pump is connectable or connected with a liquid reservoir for a second fluid. The nature of the liquid reservoir is not subject to any particular limitations but can be configured according to specific requirements.

For example, it can be provided that fluid cooling is provided for the liquid reservoir for a second fluid and the second pump. This embodiment is in particular expedient in a chromatography system which is configured as an SFC system. With this embodiment, it is possible to ensure that gas formation occurs either not at all or only slightly, wherein this point is in particular meaningful in the case of relatively low pressure in the reservoir, in the case of CO₂ 70 bar or less, in particular 60 bar or less.

In a preferred configuration, the second pump may be configured as a system for pumping a compressible liquid. A preferred system for pumping a compressible liquid is known from the prior art, for example from document WO 2019/086671 A1 having the application number PCT/EP2018/080182 filed on 5 Nov. 2018, wherein the disclosure of this document is incorporated in its entirety for disclosure purposes into the present application by reference thereto.

The pump outlet lines of the first and the second pumps are brought together in a connection piece and guided out from said connection piece into a common outlet line. A chromatography column is provided downstream, viewed in the direction of flow, of this connection piece. Such connection pieces are known per se and are not subject to any particular limitation.

Viewed in the direction of flow, an addition unit is provided upstream of the connection piece. A sample to be separated is fed into the chromatography system via the addition unit. These addition units are known per se and are also denoted sample injectors. For example, the addition unit can be configured as an infeed point via which the sample can be added to the chromatography system. In a preferred configuration, the addition unit comprises a sample loop and an injection valve via which the sample loop is switchable into flow communication with the connection piece.

The addition unit preferably comprises a sample loop into which a sample to be separated can be introduced. The sample loop is switchable into flow communication with one of the liquid reservoirs, preferably the first liquid reservoir, and the connection piece. The sample loop can be charged with a sample by an excess pressure or a reduced pressure. It can, for example, be filled by injection. Furthermore, a sample vessel can be disposed upstream of a sample loop and a waste vessel downstream of the sample loop, wherein a pump, for example a peristaltic or gear pump, which draws up a sample from the sample vessel and transfers it into the sample loop, is disposed between the sample loop and waste vessel. The volume of the sample loop can be selected according to requirements. Preferably, it can be provided that the volume of the sample loop is in the range from 0.5 ml to 30 ml, preferably in the range from 1 ml to 20 ml, particularly preferably in the range from 2.5 ml to 10 ml.

Suitable addition units are described, for example, in documents DE 10 2008 006266 A1, WO 2008/107562 A2, WO 2010/139359 A1, DE 2020/16100451 U1, WO 2018/128836 A1 and WO 2013/134222 A1, wherein the description of the addition units set out in these documents is incorporated for disclosure purposes into the present application by reference thereto.

Preferably, it can be provided that the addition unit comprises an injection valve, wherein the injection valve has at least two sample loop ports and two high-pressure ports for infeed and outfeed of high-pressure fluid.

The sample loop ports are preferably connected or connectable to a sample loop.

The sample loop can be charged by way of methods which are known from the prior art. For example, it can be provided that the sample loop is accessible by way of ports which are switchable independently of the injection valve of the addition unit.

In a preferred embodiment, it can be provided that the injection valve has at least two sample loop ports, two high-pressure ports for infeed and outfeed of high-pressure fluid and two ports for admission and delivery of sample composition and/or fluid into and from the sample loop. Further details in this respect are to be found in the description of figures.

Preferably, it can be provided that one high-pressure port is connected with a line which is connected with the first pump and the other high-pressure port is connected with a line which is connected with the connection piece.

Further, it can be provided that the addition unit is provided downstream, viewed in the direction of flow, of the first pump.

Between the connection piece and chromatography column, provision is made for a mixer switching valve and a mixer switchable by way of the mixer switching valve, wherein the mixer switching valve has at least two switching positions, wherein the mixer is connectable in a first position and the mixer is bypassable in a second position.

Further, it can be provided that the flow path of a fluid in the second position of the mixer switching valve, in which the mixer is bypassable, is shorter than in the first position of the mixer switching valve, in which the mixer is connectable. The flow path of a fluid is obtained from the flow time at a given volumetric flow rate. The flow path therefore relates to the volume occupied by a fluid. Accordingly, the volume which is occupied by a fluid between the connection piece and the chromatography column in the second position of the mixer switching valve, in which the mixer is bypassable, is smaller than in the first position of the mixer switching valve, in which the mixer is connectable.

The configuration of the mixer switching valve is not subject to any particular limitation and can be configured according to specific requirements.

Preferably, it can be provided that the mixer switching valve comprises at least four ports, wherein two ports are connected with a mixer. Further, it can be provided that one of the four ports of the mixer switching valve is connected with a line which is connected with the connection piece, and one of the four ports of the mixer switching valve is connected with a line which is connected with the chromatography column.

The chromatography system comprises at least one mixer which is switchable by way of the mixer switching valve. The mixer can be configured as an active or passive mixer. Surprising advantages can be achieved by using passive mixers. Particular, unforeseeable advantages can in particular be achieved by configuring the mixer as a static mixer. Static mixers comprise flow-influencing elements incorporated into a body which has an inlet and an outlet. For example, a tubular body provided with inert particles can be used as a static mixer.

The volume of the mixer can be selected according to the user's needs, wherein this is generally dependent on the capacity of the system, such as for example the volumetric flow rate which the system can provide. The higher the volumetric flow rate, the greater the volume of preferred mixers. Further, it can be provided that the mixer has a volume in the range from 0.5 ml to 60 ml, preferably in the range from 1 ml to 30 ml.

Further, it can be provided that a chromatographic procedure with a solvent gradient is performable with the system.

Preferably, it can be provided that the chromatography system is controllable by way of a chromatography system controller.

Further, it can be provided that the chromatography system has at least one detector. Preferably, it can be provided that the chromatography system comprises a UV detector. Furthermore, it can be provided that the chromatography system comprises a mass spectrometer as detector. In a particularly preferred embodiment, the system comprises a UV detector and a mass spectrometer.

Furthermore, the chromatography system can have a fraction collector by way of which the purified samples can be collected.

In a particularly preferred configuration of the present invention, it can be provided that the chromatography system is configured as an SFC system. The system, preferably chromatography system, here has a chromatography column and, viewed in the direction of flow, at least one downstream backpressure regulator.

Particularly preferably, it can be provided that a gas-liquid separator is provided downstream of the backpressure regulator viewed in the direction of flow.

Such an SFC chromatography system is for example operated using supercritical CO₂ together with a solvent, for example methanol. Accordingly, a chromatography system designed for supercritical fluid chromatography has at least one storage vessel for the first solvent and one storage vessel for the supercritical fluid, for example CO₂. In general, the fluid is withdrawn from the storage and transferred with in each case at least one pump into a mixer which is in flow communication with a chromatography column. The pumps and/or the mixer as well as the chromatography column can be provided with a temperature controller in order in each case to be able to set a predetermined temperature. For this purpose, heat exchangers in particular can be provided. The addition of mixtures to be separated, in particular substances to be purified, can be effected by an addition unit which was described in more detail above and is preferably provided in the line in which the solvent is fed to the mixer.

The fluid leaving the chromatography column is preferably fed at least in part to a detection or analysis unit. Examples of a detection or analysis unit are, inter alia, UV detectors and/or mass spectrometers.

Preferably, it can be provided that the chromatography system comprises an injection device with which samples can be injected automatically into the chromatography system.

The fluid leaving the chromatography column is preferably fed at least in part to a detection or analysis unit. Preferably, it can be provided that the chromatography system comprises a UV detector. Furthermore, it can be provided that the chromatography system comprises a mass spectrometer as detector. In a particularly preferred embodiment, the system comprises a UV detector and a mass spectrometer. Here, further detection methods can also be used that measure, for example, light scattering, fluorescence or refractive index. Further, mass spectrometers and/or conductivity detectors etc. are frequently used.

Downstream of the chromatography column and preferably downstream of the detection or analysis unit, a backpressure regulator is generally provided, and preferably a heat exchanger is provided downstream of the backpressure regulator. The aerosol leaving the heat exchanger is preferably subsequently fed to a gas-liquid separator.

Gas-liquid separators which are preferably to be used are known from the prior art, for example from document WO 2014/012962 A1 having the application number PCT/EP2013/06067 filed on 17 Jul. 2013, wherein the disclosure of this document is incorporated in its entirety for disclosure purposes into the present application by reference thereto.

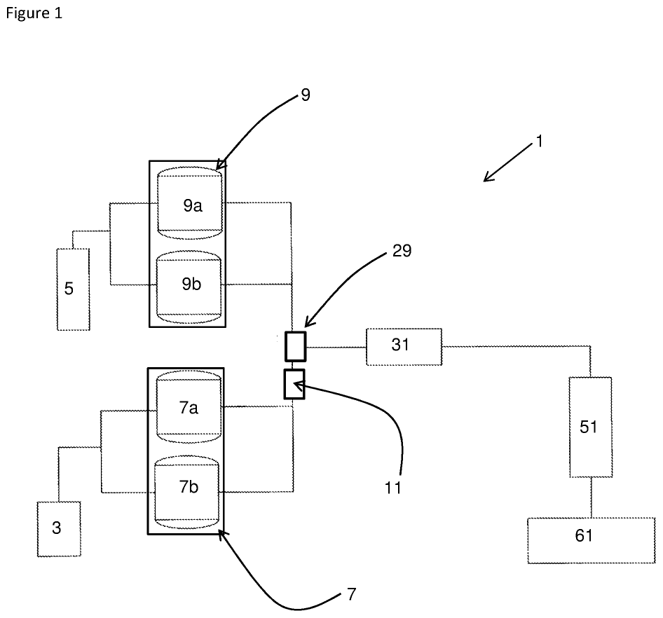

One gas-liquid separator which is particularly preferably to be used is set out in PCT application WO 2018/210818 A1 having the application number PCT/EP2018/062537 filed on 15 May 2018, wherein the disclosure of this document, in particular the gas-liquid separator set out therein and the preferred embodiments of the gas-liquid separator, is incorporated in its entirety for disclosure purposes into the present application by reference thereto. In particular, the embodiments of the gas-liquid separator shown in FIGS. 1 to 9, are incorporated for disclosure purposes into the present application by reference to the PCT application having the application number PCT/EP2018/062537.

An unexpected improvement of baffle separation can be achieved by disposition and configuration of a separation opening. Hereby, in particular, the gas volume provided on baffle separation can be reduced, such that the total volume of the gas-liquid separator can be reduced. Surprisingly, the separation efficiency of the chromatography system can improved hereby.

A preferred gas-liquid separator comprises a separation zone with an inlet nozzle, a baffle unit and a gas-guiding unit.

Preferably, the separation zone is configured such that a baffle separation is effected. Baffle separation means that the liquid droplets in the aerosol are directed against a baffle unit, and as a result thereof, the liquid droplets can form a liquid film.

The baffle unit can here be any body against which the aerosol flow can be directed. For example, the aerosol stream can be directed against an upper region of the separation zone, for example against an upper closure of the separation zone. Here, a projection, for example a mandrel or the like, can be provided, onto which the aerosol stream impinges, such that the liquid droplets directed onto the baffle unit are not thrown back or rebound from the baffle unit, but instead form a film.

A preferred gas-liquid separator uses gravitation during operation, which effects a separation of gas and liquid. Accordingly, the expression above refers to the orientation of the gas-liquid separator that is in operation, such that a gas can flow out upward while the contrary direction in which a liquid exits the gas-liquid separator is at the bottom thereof.

Besides a baffle unit, an inlet nozzle is preferably provided in the separation zone of the gas-liquid separator. Through the inlet nozzle, the aerosol is introduced into the gas-liquid separator, in particular into the separation zone of the gas-liquid separator.

Here, the inlet nozzle is preferably configured such that a gas-liquid flow directed through the inlet nozzle is able to impinge against the baffle unit, as has already been explained with regard to the baffle unit.

The shape and nature of the inlet nozzle are not critical, such that a person skilled in the art can choose them within the scope of their abilities. Thus, the inlet nozzle can be configured such that the aerosol is directed onto the baffle unit in the form of a very narrow jet. Further, the inlet nozzle can also be constructed in such a way that a conical spray mist is directed onto the baffle unit.

The gas-liquid separator preferably has a separation opening that is disposed between the deposition zone and the separation zone, such that there is a connection open to gas and liquid between these zones. The separation opening preferably effects an inertial deposition. This means that liquid flowing downward on the baffle unit and/or the gas-guiding unit in the form of a liquid film will separate from the gas by inertia. Here, the gas preferably accelerates the liquid such that the liquid is transferred into the separation zone at a higher velocity than without this gas acceleration. Here, the liquid film preferably remains on a wall of the deposition zone, which is preferably configured as part of the baffle unit and/or the gas-guiding unit, in the form of a film and passes directly into the separation zone without the liquid film leaving this wall that continues into the separation zone. In contrast to the liquid phase, the gas phase does not adhere to a wall, but is able to exit upward and pass into the gas discharge zone. In contrast to this, the liquid is discharged into the separation zone and removed from the gas-liquid separator through the liquid outlet provided in the separation zone.

Preferably, the distance of the inlet nozzle from the baffle unit is greater than the smallest length extension of the deposition opening. Here, the distance of the inlet nozzle from the baffle unit results from the path of the aerosol from leaving the inlet nozzle until it impinges on the baffle unit. The smallest length extension of the deposition opening relates to the width or length of the deposition opening, wherein the extension of the plane up to the edge of the deposition opening is related to the plane between the deposition zone and the separation zone that leads to a minimal area of the deposition opening. In this plane, in which the deposition opening lies, the length of the longest extension of the deposition opening is determined, such that the shortest length of the deposition opening that is perpendicular to the longest extension of the deposition opening can then be measured. This smallest length extension can also be regarded as the width of the deposition opening here.

The spatial shape of the deposition zone is not critical and can be adapted as needed. Here, a gas-guiding unit is preferably formed in the deposition zone. The gas-guiding unit effects a change in the flow velocity of a gas, such that a lower gas velocity prevails in the region of the inlet nozzle than in the region of the deposition opening. Since the volumetric flow rate can be regarded as constant while the aerosol composition remains identical, this means that the aerosol is first led into a relatively large space that is subsequently narrowed, such that the flow velocity increases.

Accordingly, the cross-sectional area of the deposition zone can, for example, be circular, wherein said area preferably narrows, for example, in the manner of a wedge from the inlet nozzle toward the deposition opening. In a preferred embodiment, the deposition zone does not have a circular cross-sectional area in the region of the inlet nozzle, wherein the deposition zone preferably comprises at least three side walls which, together with an upper closure, define a space which is connected with the separation zone by way of the deposition opening.

The gas discharge zone serves to discharge the gas phase from the gas-liquid separator, such that it comprises a gas outlet.

Preferably, the gas discharge zone is configured such that the gas velocity at the gas outlet is at a maximum, preferably the gas velocity increases in the gas flow direction from the separation zone in the direction of the gas outlet. Hereby, a suction effect can be brought about that leads to reliable and low-maintenance operation of the gas-liquid separator. Further, the volume of the gas-liquid separator can be reduced hereby without any decline in performance in other characteristics, for example separation characteristics.

In reverse of the deposition zone, the space therefore decreases from the direction of the separation zone toward the gas outlet. Preferably, the cross-sectional area tapers from the direction of the separation zone toward the gas outlet.

Depending on the nature of the gas, the gas phase of the aerosol can be collected and processed or, for example, when CO₂ is used, also released into the environment.

The liquid phase of the aerosol is preferably collected in a fraction collector. It is particularly preferred that the fractions collected are automatically collected as main fractions, while excess solvent can be subjected to processing or disposal. The connecting line between the liquid outlet of the gas-liquid separator and the fraction collector can preferably be configured such that residues of the gas phase, preferably CO₂ residues, can escape via this connection. A semipermeable plastic material, for example Teflon, particularly preferably AF 2400 (commercially available from DuPont), can be used for this purpose.

A preferred method for operating a fractionation collector in a chromatographic procedure is known from the prior art, for example document WO 2019/048369 A1 having the application number PCT/EP2018/073503 filed on 3 Sep. 2018, wherein the disclosure of this document is incorporated in its entirety for disclosure purposes into the present application by reference thereto.

Further, it can be provided that the chromatography system comprises a chromatography system controller which is operatively connected with a detector and a fraction collector. The controller is preferably programmable such that the quantity of liquid introducible into a vessel of the fraction collector is determinable as a function of the proportion of the first solvent.

Furthermore, it can be provided that the chromatography system comprises a chromatography system controller which is operatively connected with the first pump, wherein the pump output of the first pump is controllable by way of the chromatography system controller. The chromatography system controller can additionally be operatively connected with the second pump and control the pump output thereof.

The chromatography system is preferably configured as an SFC system, wherein a chromatographic procedure with a solvent gradient is performable.

The SFC chromatography system is preferably operated at a volumetric flow rate in the range from 10 ml/min to 450 ml/min, particularly preferably in the range from 50 ml/min to 300 ml/min and especially preferably 100 ml/min to 250 ml/min. Furthermore, it can be provided that the SFC chromatography system is preferably operated at a volumetric flow rate of at least 10 ml/min, particularly preferably of at least 50 ml/min and especially preferably of at least 100 ml/min.

The chromatography system can furthermore be configured as an HPLC system. An HPLC system differs from an SFC system inter alia in that an HPLC system does not have a backpressure regulator which, in particular viewed in the direction of flow, is disposed downstream of a chromatography column. Furthermore, HPLC systems do not have a gas-liquid separator downstream, viewed in the direction of flow, of the backpressure regulator.

Another aspect also provides a conversion kit, by way of which a high-performance liquid chromatography system (HPLC) can be converted into an SFC system. Such a kit comprises at least one gas-liquid separator and at least one mixer switching valve, as described above. The kit preferably contains further components, as described above and below, in order to convert an HPLC system into an SFC system, such as heat exchangers or backpressure regulators.

Different components are required depending on the specific configuration of the system to be converted. In the most favorable case, one of the pumps of the HPLC system is suitable for operation with a compressible liquid, in particular with liquid or supercritical CO₂.

The present invention also provides a method for carrying out a chromatographic procedure comprising the use of a chromatography system according to the invention.

Preferably, it can be provided that, on application of a sample to be separated to the chromatography column, the mixer switching valve is switched into the second position and the fluid is bypassed around the mixer.

Furthermore, it can be provided that, on application of a sample to be separated to the chromatography column, the mixer switching valve is switched into the first position and the fluid is passed through the mixer. During operations that serve to prepare the system for a chromatographic procedure, for example for cleaning the column or for controlling the temperature thereof, the mixer can preferably be connected in.

In a preferred embodiment, it can be provided that the second position of the mixer switching valve, in which the fluid is bypassed around the mixer, is selected to be as short as possible. This means that the time interval which is required to pass a sample through the mixer switching valve is precalculated as accurately as possible and the mixer switching valve is held in the second position for as short a time as possible in accordance with this calculation. This calculation should take account, inter alia, of the volume between the addition unit and the mixer switching valve, the addition volume of the sample itself, the volume of the mixer switching valve including the flow path for bypassing the mixer and the volumetric flow rate.

In one embodiment, an SFC-method is carried out. For this purpose, it can be provided that the liquid reservoir for a first fluid contains a first solvent which is liquid under standard conditions, and the liquid reservoir for a second fluid contains which is gaseous under standard conditions.

With regard to the term “SFC method” or “supercritical fluid chromatography”, it should be noted that a supercritical state need not necessarily be achieved or maintained over the entire course of a chromatographic procedure. Instead, the term “SFC method” or “supercritical fluid chromatography” means that a chromatography operation is carried out using a substance which is compressible and readily transformed into supercritical state and is preferably gaseous under standard conditions.

In an SFC method, a solvent composition is preferably pumped into a chromatography column which contains at least a proportion of a first solvent which is liquid under standard conditions and a proportion of a second solvent which is gaseous under standard conditions. This is therefore preferably an SFC procedure as set out above and below. Normal conditions mean 273.15 K=0° C. and 1.01325 bar according to DIN 1343.

A separation is carried out with a supercritical fluid by using an inorganic or organic solvent which is liquid under usual separation conditions, preferably at 25° C. and atmospheric pressure (1013.25 mbar). Here, a polar or non-polar solvent can be used, depending on the nature of the compounds to be separated or purified. These substances are referred to here in particular as the first solvent.

Preferably, the first solvent is selected from alcohol, preferably methanol, ethanol or propanol, hexane, mixtures with dichloromethane, chloroform, water (preferably up to a maximum of 3% by volume, since otherwise a miscibility gap can occur), an aldehyde or a ketone, preferably methyl ethyl ketone; an ester, preferably ethyl acetate; or an ether, preferably tetrahydrofuran, an aliphatic hydrocarbon, preferably hexane, cyclohexane, heptane, octane; an aromatic hydrocarbon, preferably benzene, toluene, xylene. These compounds can be used individually or as a mixture.

Further, it can be provided that in a method according to the invention a gas is preferably used which can be brought into a supercritical state relatively easily. Preferred gases which have these properties include, inter alia, carbon dioxide (CO₂), ammonia (NH₃), Freon, xenon, wherein carbon dioxide (CO₂) is particularly preferred. These substances are referred to here in particular as the second solvent.

Preferably, it can be provided that the gas-liquid mixture to be brought into the supercritical state comprises a polar solvent and a gas that is selected from the group consisting of CO₂, NH₃, Freon, xenon, preferably CO₂. Preferably, the polar solvent is an alcohol, preferably methanol, ethanol or propanol, hexane, mixtures with dichloromethane, chloroform, water (preferably up to a maximum of 3% by volume, since otherwise a miscibility gap can occur), an aldehyde or a ketone, preferably methyl ethyl ketone; an ester, preferably ethyl acetate; or an ether, preferably tetrahydrofuran.

Further, it can be provided that the gas-liquid mixture to be brought into the supercritical state comprises a non-polar solvent and a gas that is selected from the group consisting of CO₂, NH₃, Freon, xenon, preferably CO₂. Preferably, the non-polar solvent is an aliphatic hydrocarbon, preferably hexane, cyclohexane, heptane, octane; an aromatic hydrocarbon, preferably benzene, toluene, xylene; an ester, preferably ethyl acetate; or an ether, preferably tetrahydrofuran.

The composition flowing from the chromatography column is preferably introduced at least in part into a detector. Accordingly, a verification of the corresponding composition is preferably undertaken downstream of the chromatography column. Detectors that can be used for this are generally known, wherein in particular spectroscopy methods in which electromagnetic waves are used, such as UV and VIS spectroscopy, are carried out. Here, further detection methods can also be used that measure, for example, light scattering, fluorescence or refractive index. Further, mass spectrometers and/or conductivity detectors etc. are frequently used.

These methods can measure continuously or in batches the properties of the composition flowing out of the chromatography column, such that these detectors can determine these properties in flow or by sampling, wherein the latter occurs generally fully automatic and continuously. Details of these techniques are known from the prior art, for which reference is made in particular to detectors as are used in conventional HPLC methods.

After leaving the chromatography column, a first composition containing the first solvent is introduced into a collecting vessel of the fraction collector as a function of the detector signal. Particularly preferably, it can be provided that the quantity of liquid which is introduced into a collecting vessel of the fraction collector is selected as a function of the proportion of this first solvent.

Through this measure, it can be achieved in particular that the volume of a collecting vessel of the fraction collector can be surprisingly well utilized. In this manner, in particular the cost and handling advantages set out above can be achieved.

Further cost and handling advantages can be achieved in that at least a part of the composition that contains the first solvent is not introduced into a collecting vessel after leaving the chromatography column. Compositions that do not contain valuable substances are preferably discarded, wherein this is generally effected by a control valve in the fraction collector that directs the proportions of the composition containing the first solvent to be discarded after leaving the chromatography column into a waste container or the like.

In a particular configuration, it can be provided that the solvent composition pumped into a chromatography column is changed over the course of the chromatographic procedure.

The proportion of first solvent in the solvent composition is preferably increased over the course of the chromatographic procedure and the proportion of second solvent reduced over the course of the chromatographic procedure, wherein, based on the solvent composition, the proportion of first solvent at the beginning of the chromatographic procedure is particularly preferably at least 5 vol. %, especially preferably at least 10 vol. %, in particular especially preferably at least 20 vol. % below the proportion of first solvent at the end of the chromatographic procedure. Accordingly, the portion of the solvent that is liquid under normal conditions preferably increases, while the proportion of the solvent that is gaseous under standard conditions decreases. Through this configuration, incrustation in a gas separator that is used in a preferred configuration of the method, can be surprisingly minimized, preferably completely prevented. In this way, the separation quality of the system or of the method can be surprisingly improved.

Further, it can be provided that the proportion of the first solvent lies in the range from 5 to 95% by volume and the portion of the second solvent lies in the range from 5 to 95% by volume, based on the solvent composition.

Preferably, it can be provided that the chromatographic procedure is carried out at a pressure in the range from 50 to 500 bar, preferably 75 to 400 bar.

In a preferred embodiment, it can be provided that the chromatography is carried out at a temperature in the range from 20° C. to 80° C., preferably 35° C. to 60° C.

In a preferred embodiment, it can be provided that the second solvent that is contained in the composition downstream of the chromatography column is at least partially separated off before the composition is introduced into the fraction collector. Hereby, a significant improvement in economy can surprisingly be achieved because part of the solvent is separated off upstream of the fraction collector and, as a result, at constant volume of the collecting vessels, the collecting vessels require changing less often.

The gas-liquid separator can generally be operated at atmospheric pressure. However, to avoid accumulation of larger amounts of liquid, e.g. of methanol, the gas-liquid separator can be operated at a moderate internal backpressure, for example, in the range from 0.1 bar to 25 bar by a backpressure regulator. Accordingly, it can be provided that in the chromatography system, downstream of the gas outlet, a backpressure regulator is provided that is preferably controllable in the range from 1 bar to 25 bar excess pressure (absolute pressure 2 bar to 21 bar), preferably 2 bar to 15 bar excess pressure. The liquid component collected via the separation zone and made available through the liquid outlet channel nonetheless enables automated fractionation that can be operated under atmospheric pressure. With the assistance of the gas-liquid separator and comparable to conventional HPLC analysis, fully automated fraction collection can also be performed for SFC analysis.

Accordingly, it can be provided that a gas-liquid separator is used, wherein the pressure in the gas-liquid separator is preferably in the range from 0.1 to 25 bar, preferably 0.5 to 20 bar and particularly preferably 1 to 15 bar (excess pressure). Through this configuration, further surprising improvements can be achieved. In particular, the run time between the expansion of the solvent mixture and the outlet of the gas-liquid separator is essentially determined by the pressure drop. The gas generated in a small volume effects a high pressure, which is decisive for the run time. The relative constancy of this pressure leads to a high signal integrity, since the run time remains essentially constant even after expansion when using a suitable gas-liquid separator. Accordingly, in particular when using a gas-liquid separator that can be operated preferably at an excess pressure, it is possible to dispense with an addition of solvents, as has been used according to the prior art, in order to ensure signal integrity. Here, it is to be noted that absolute constancy of the gas pressure in the gas-liquid separator is not necessary, since the run time is very short even at relatively low pressures, such that fluctuations have no significant effect on signal integrity, as this is subject to normal fluctuation due to error tolerances. Accordingly, pressure fluctuations in the range of 0.1 bar to 25 bar in the gas-liquid separator lead to expedient results. Preferred embodiments of suitable gas-liquid separators are described previously and below, wherein reference is made thereto.

A preferred embodiment of the method, in which the chromatography system comprises a backpressure regulator, by way of which the pressure in the gas-liquid separator is closed-loop controllable, can provide that the pressure is closed-loop controlled as a function of the solvent content of the gas-liquid mixture, said control preferably being configured such that a high pressure is provided in the gas-liquid separator when the solvent content is high.

Preferably, it can be provided that fractionation is operated at a lower pressure than the gas-liquid separator, wherein the pressure difference is preferably in the range from 0.1 to 25 bar, preferably 0.5 to 20 bar and particularly preferably 1 to 15 bar.

Fractionation is preferably carried out at a pressure in the range from 0 to 1 bar (excess pressure), particularly preferably 0 to 0.5 bar, especially preferably 0 to 0.2 bar. The pressure values set out above relate to excess pressure, wherein this pressure is measured relative to atmospheric pressure or air pressure.

The detection of a fraction to be collected can be determined in the usual manner that is generally also used in related chromatography methods. This includes, for example, a fraction being collected at a certain signal level of the detector, for example a UV/VIS detector. Further, a fraction can also be collected on the basis of a certain shape of the signal, for example the predetermined change in the slope of the detector signal or a certain value of the slope of the detector signal.

Further, it can be provided that the chromatography is carried out at a flow rate in the range from 10 ml/min to 450 ml/min, particularly preferably in the range from 50 ml/min to 300 ml/min and especially preferably 100 ml/min to 250 ml/min. This flow rate represents the total flow rate. The flow rate of the individual solvents, in particular the first or the second solvent that are each used as a mixture, results from the respective proportion by volume.

Further, it can be provided that the fraction collector is controlled by way of a control unit and the control unit is operatively connected with the detector, wherein, on detection of a substance by the detector, a control pulse which effects a change of collecting vessel is sent to the fraction collector.

In a further embodiment, it can be provided that the fraction collector is controlled by way of a control unit and the control unit is operatively connected with the detector, wherein, after the detection of a substance by the detector has ended, a control pulse is sent to the fraction collector, which effects a change of collecting vessel. This configuration is preferred over the embodiment in which a change of collecting vessel is effected at the beginning.

In the following, preferred embodiments of the present invention are to be described by way of example with reference to four figures, without this being in any way intended to restrict the invention. In the figures:

FIG. 1 is a schematic representation of a chromatography system,

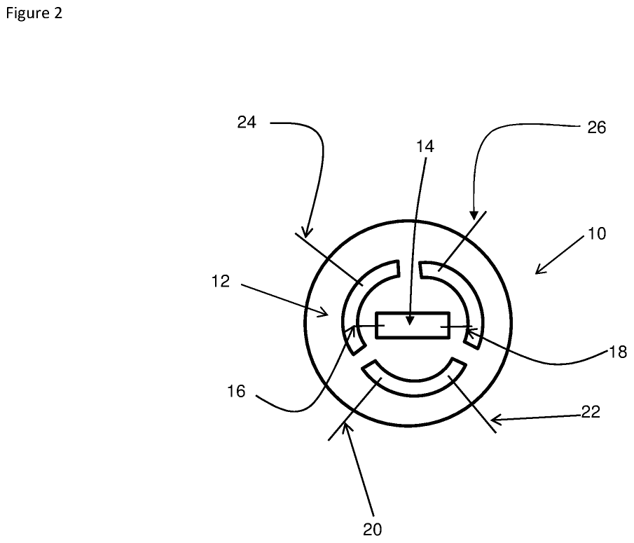

FIG. 2 is a schematic representation of a preferably usable addition unit in a first switching position,

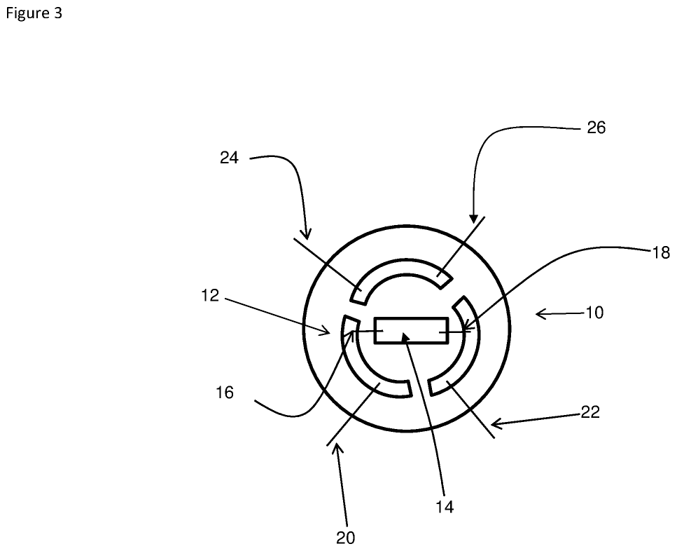

FIG. 3 is a schematic representation of a preferably usable addition unit in a second switching position,

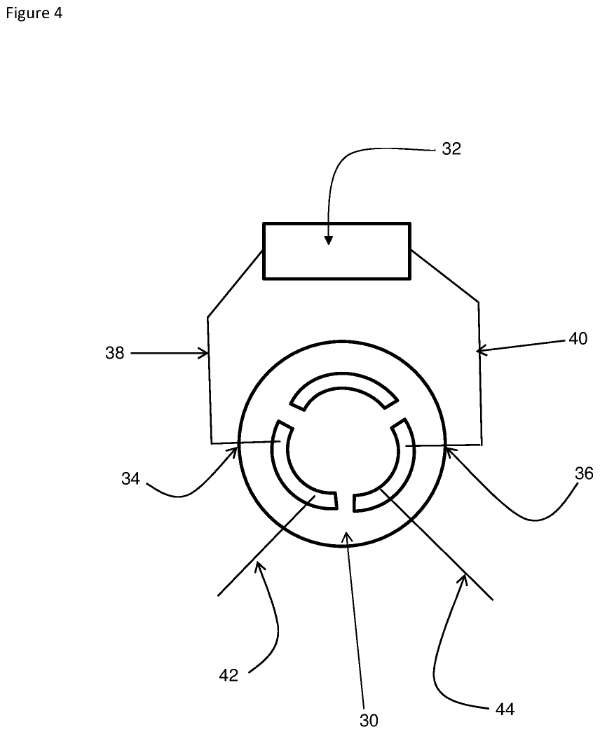

FIG. 4 is a schematic representation of a preferably usable mixer switching valve in a first switching position,

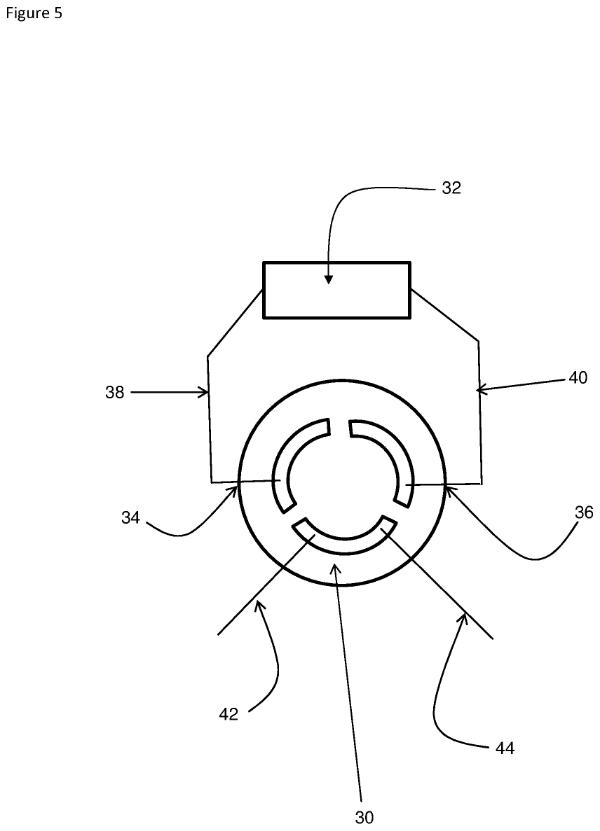

FIG. 5 is a schematic representation of a preferably usable mixer switching valve in a second switching position,

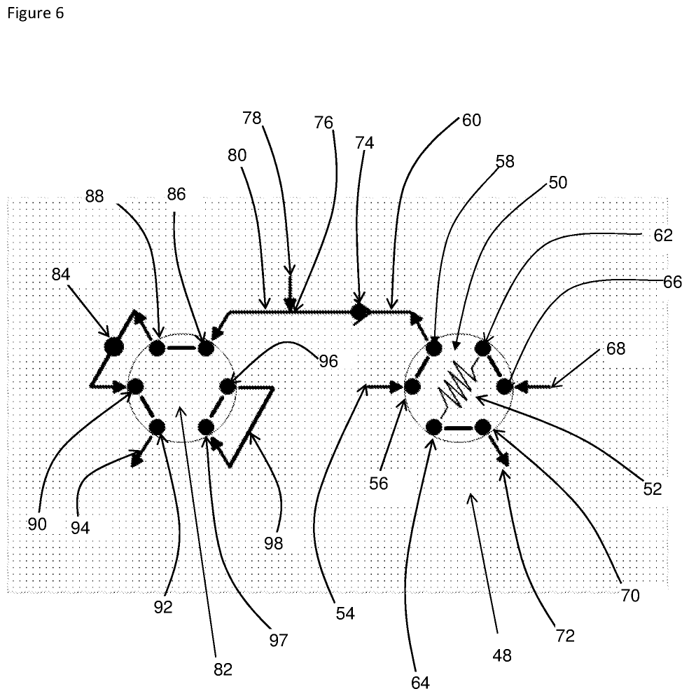

FIG. 6 is a schematic representation of a portion of a chromatography system, wherein a preferably usable addition unit is in a second switching position and a preferred mixer switching valve is in a first switching position,

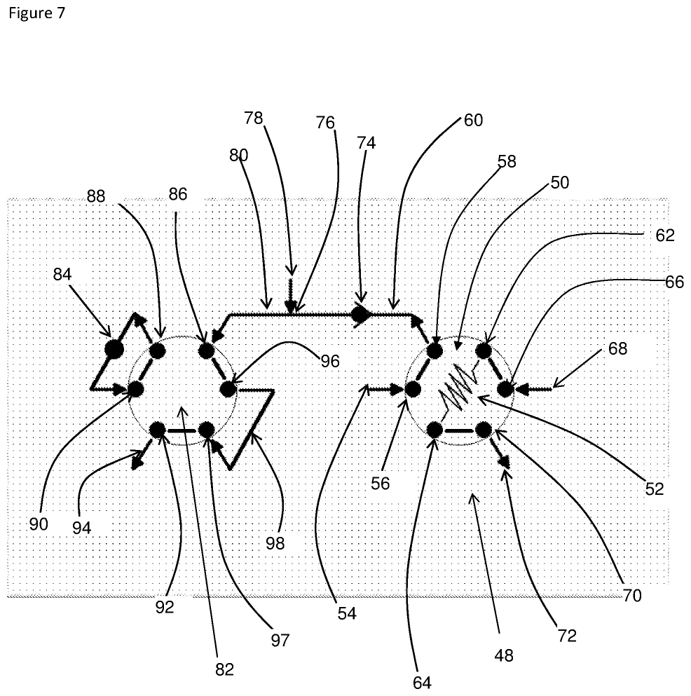

FIG. 7 is a schematic representation of a portion of a chromatography system, wherein a preferably usable addition unit is in a second switching position and a preferred mixer switching valve is in a second switching position,

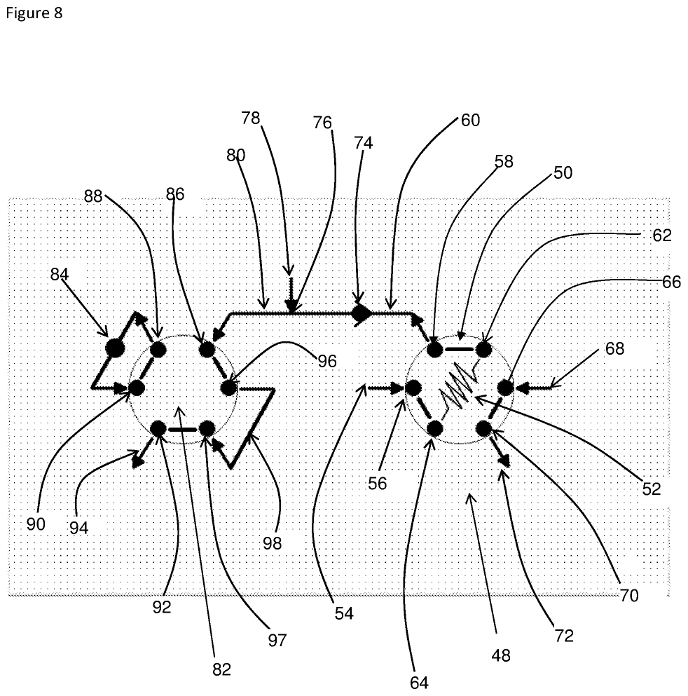

FIG. 8 is a schematic representation of a portion of a chromatography system, wherein a preferably usable addition unit is in a first switching position and a preferred mixer switching valve is in a second switching position,

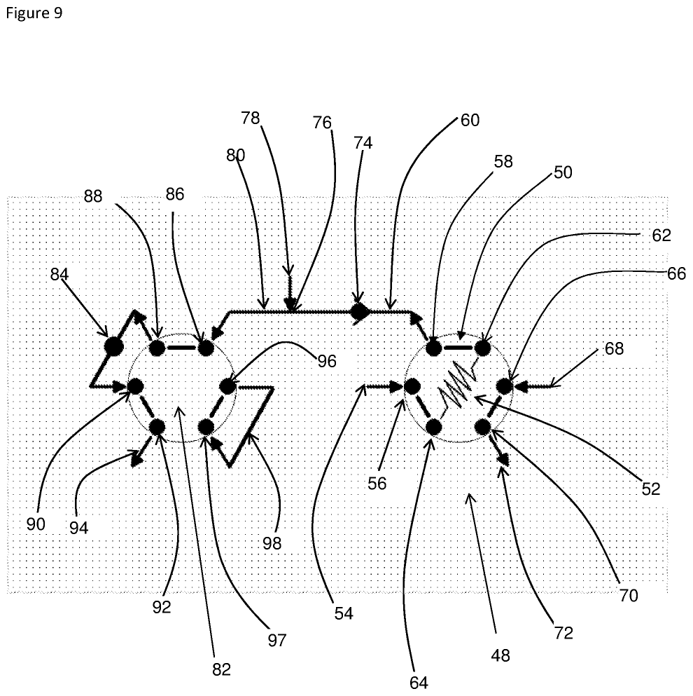

FIG. 9 is a schematic representation of a portion of a chromatography system, wherein a preferably usable addition unit is in a first switching position and a preferred mixer switching valve is in a first switching position,

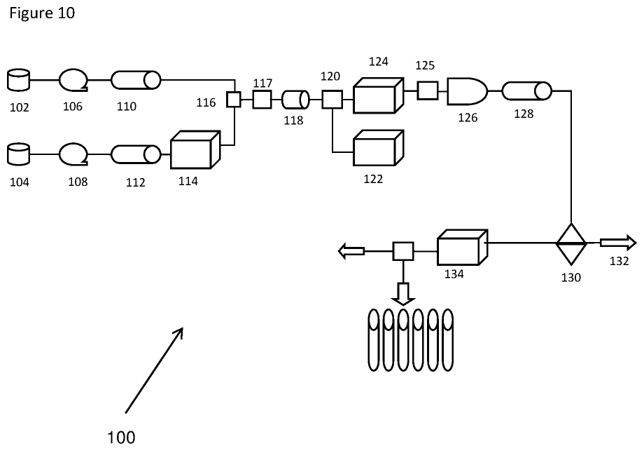

FIG. 10 is a schematic representation of a chromatography system configured as an SFC system.

FIG. 1 shows a schematic representation of a chromatography system 1, as may for example be configured as an HPLC system.

A suitable chromatography system 1 comprises two fluid streams, wherein a first fluid is provided by a first liquid reservoir 3 and a second fluid by a second liquid reservoir 5. The first fluid is transferred from the liquid reservoir 3 by a pump 7, which in the present case comprises two pistons 7a, 7b, into a connection piece 29. Viewed in the direction of flow, an addition unit 11 is provided upstream of the connection piece 29, wherein, in the present embodiment, said unit is disposed downstream of the pump 7. In a further embodiment, the addition unit 11 can also be disposed upstream of the pump 7.

FIGS. 2 and 3 show a preferred embodiment of an addition unit 11.

The second fluid is transferred from the liquid reservoir 5 by a pump 9, which in the present case comprises two pistons 9a, 9b, into the previously shown connection piece 29, such that, downstream of the connection piece 29, a composition is obtained which is mixed by the mixer 31 which, viewed in the direction of flow, is disposed downstream of connecting piece 29, when the mixer is connected in. The mixer is switchable by way of a mixer switching valve, which is not shown for reasons of clarity, such that the mixer 31 is connectable in a first position and the mixer 31 is bypassable in a second position.

FIGS. 4 and 5 show a preferred embodiment of a mixer switching valve, which is connected with a mixer.

In the present chromatography system 1, a chromatography column 51 is disposed downstream of the connection piece 29 and the mixer 31. In the present case, a fraction collector 61 is preferably provided downstream of the chromatography column 51.

The fraction collector 61 can be controlled by way of one or more control units, which are not shown here, wherein these control units are operatively connected with one or more detectors. Viewed in the direction of flow, the detectors are connected between chromatography column 51 and fraction collector 61.

In general, the mixer switching valve is switched into the first position and the fluid is passed through the mixer. This is in particular the case during the actual separation of the sample composition.

For application of a sample to be separated to the chromatography column, the mixer switching valve is switched into the second position and the fluid is bypassed around the mixer.

FIG. 2 describes a preferably usable addition unit 10 in a schematic representation in a first switching position.

The addition unit 10 shown in FIG. 2 comprises an injection valve 12 and a sample loop 14. The injection valve 12 shown in FIG. 2 comprises 6 ports (16, 18, 20, 22, 24, 26), wherein two ports are configured as sample loop ports (16, 18), two ports (20, 22) as high-pressure ports for the infeed and outfeed of high-pressure fluid, and two ports (24, 26) as ports for the infeed and outfeed of sample composition and/or fluid into and from the sample loop. The ports 16 and 18 are here connected with the sample loop 14 and configured as sample loop ports. The ports 20 and 22 serve as high-pressure ports for the infeed and outfeed of high-pressure fluid. A sample can be introduced into the sample loop 14 and fluid guided out of the sample loop by way of ports 24 and 26. These ports 24, 26 serve as injection and waste ports respectively. In the present embodiment, port 20 is connectable or connected in flow communication with a liquid reservoir for a first fluid and port 22 with a connection piece, wherein the liquid reservoir for a first fluid and the connection piece are not shown in FIG. 2.

In the first switching position, a sample can be introduced into the sample loop 14, wherein this may proceed via port 24 by way of a syringe or a pump, as is known from the prior art. The sample loop 14 can be charged with a sample by an excess pressure or a reduced pressure. It can, for example, be filled by injection. Furthermore, a sample vessel can be disposed upstream of the sample loop 14 and a waste vessel downstream of the sample loop, wherein a pump, for example a peristaltic or gear pump, which draws up a sample from the sample vessel and transfers it into the sample loop 14, is disposed between the sample loop 14 and waste vessel. Fluid which is present in the sample loop prior to sample introduction is here transferred via port 26 into a waste vessel which is not shown. This fluid preferably substantially consists of the first solvent.

FIG. 3 describes a preferably usable addition unit 10 in a schematic representation in a second switching position. As described in FIG. 2, the addition unit 10 comprises an injection valve 12 and a sample loop 14, wherein the injection valve 12 comprises six ports (16, 18, 20, 22, 24, 26) which are described in greater detail in FIG. 2.

FIG. 3 shows the addition unit 10 in a second switching position in which a sample from the sample loop 14 is applied to a chromatography column. In this switching position, the sample loop 14 is switched into the flow path between a liquid reservoir for a first fluid and a connection piece. In this switching position of the injection valve 12, a fluid from a first liquid reservoir is introduced into the sample loop 14 via port 20 or port 16 and discharged into a connection piece via port 18 or port 22.

FIG. 4 describes a preferably usable mixer switching valve 30 in a first switching position. The mixer 32 shown in FIG. 4 is connected with the mixer switching valve 30 via ports 34 and 36 and lines 38 and 40. The ports 42 and 44 serve as high-pressure ports for the infeed and outfeed of high-pressure fluid. In the present embodiment, port 42 is in flow communication with a connection piece and port 44 with a chromatography column, wherein the connection piece and the chromatography column are not shown in FIG. 4.

The mixer switching valve 30 described in FIG. 4 has two switching positions, wherein, in the first position shown, the mixer 32 is connected in, such that a fluid or a fluid mixture is passed from a connection piece via the mixer 32 into a chromatography column.

FIG. 5 describes a preferably usable mixer switching valve 30 in a second switching position. The mixer 32 shown in FIG. 5 is connected with the mixer switching valve 30 via ports 34 and 36 and lines 38 and 40. The ports 42 and 44 serve as high-pressure ports for the infeed and outfeed of high-pressure fluid. In the present embodiment, port 42 is in flow communication with a connection piece and port 44 with a chromatography column, wherein the connection piece and the chromatography column are not shown in FIG. 5.

The mixer switching valve 30 described in FIG. 5 has two switching positions, wherein, in the second position shown, the mixer 32 is bypassed, such that a fluid or a fluid mixture is passed from a connection piece not via the mixer 32 but instead directly into a chromatography column.

FIG. 6 shows a schematic representation of a portion of a chromatography system, wherein a preferably usable addition unit 48 is in a second switching position and a preferred mixer switching valve 82 is in a first switching position.

The addition unit 48 comprises an injection valve 50 and a sample loop 52. The injection valve 50 shown in FIG. 6 comprises 6 ports (56, 58, 62, 64, 66, 70). The addition unit 48 and injection valve 50 are switched such that a sample can be introduced into the sample loop 52. To this end, a sample can be fed into the sample loop 52 via sample inflow line 68, which is connected with port 66 for conveying sample composition and/or fluid into and from the sample loop. The sample loop 52 is connected with the injection valve 50 via ports 62 and 64. The sample loop 52 can be charged with a sample by an excess pressure or a reduced pressure. It can, for example, be filled by injection. Furthermore, a sample vessel can be disposed upstream of the sample loop 52 and a waste vessel downstream of the sample loop, wherein a pump, for example a peristaltic or gear pump, which draws up a sample from the sample vessel and transfers it into the sample loop 52, is disposed between the sample loop 52 and waste vessel. Fluid which is present in the sample loop prior to sample introduction is here transferred via port 70 and line 72 into a waste vessel which is not shown. This fluid preferably substantially consists of the first solvent.

In the second switching position of the addition unit 48 or injection valve 50, fluid is transferred from a liquid reservoir for a first fluid via line 54 into line 60 via two high-pressure ports 56, 58 for the infeed and outfeed of high-pressure fluid. A non-return valve 74 is provided in line 60. The line 60 is connected with a connection piece 76 which is furthermore connected with an inflow line 78 for a second fluid. The common outlet line 80 is connected via port 86 with a mixer switching valve 82. The mixer switching valve 82 is connected via ports 88 and 90 with a mixer 84 and via port 92 with a line 94 which leads into a chromatography column, wherein the chromatography column is not shown in FIG. 6. In FIG. 6, the mixer switching valve 82 is in a first switching position in which a fluid or a fluid mixture is passed from the connection piece 76 via the mixer 84 into a chromatography column.

In the present embodiment, the mixer switching valve 82 is connected via ports 96 and 97 with a bypass loop 98.

In the configuration shown in FIG. 6, the chromatography column, which is not shown, can for example be equilibrated with a suitable fluid mixture before a sample is applied.

FIG. 7 shows a schematic representation of a portion of a chromatography system, wherein a preferably usable addition unit 48 is in a second switching position and a preferred mixer switching valve 82 is in a second switching position.

The portion shown in FIG. 7 therefore corresponds in many details to that shown in FIG. 6, wherein the same reference signs denote identical components, such that the explanations provided in respect of FIG. 6 also apply to FIG. 7.

As described in FIG. 6, the addition unit 48 comprises an injection valve 50 and a sample loop 52, wherein the injection valve 50 comprises six ports (56, 58, 62, 64, 66, 70) which are described in greater detail in FIG. 6. The position of the addition unit 48 and injection valve 50 is described in FIG. 6, such that reference is made thereto in order to avoid repetition.

A fluid is passed into the mixer switching valve 82 via line 60 and the connection piece 76, wherein details of the mixer switching valve 82, in particular the connection thereof with the mixer 84 and the bypass loop are described in FIG. 6.

In FIG. 7, the mixer switching valve 82 is in a second switching position in which a fluid or a fluid mixture is passed from the connection piece 76 not into mixer 84, but instead via the bypass loop 98 into a chromatography column.

The configuration shown in FIG. 7 can be for example be adopted shortly before sample application in order to ensure the mixer 84 is bypassed.

FIG. 8 shows a schematic representation of a portion of a chromatography system, wherein a preferably usable addition unit is in a first switching position and a preferred mixer switching valve is in a second switching position.

The portion shown in FIG. 8 therefore corresponds in many details to that shown in FIGS. 6 and 7, wherein the same reference signs denote identical components, such that the explanations provided in respect of FIGS. 6 and 7 also apply to FIG. 8.

As described in FIG. 6 or 7, the addition unit 48 comprises an injection valve 50 and a sample loop 52, wherein the injection valve 50 comprises six ports (56, 58, 62, 64, 66, 70) which are described in greater detail in FIG. 6.

In FIG. 8, the addition unit 48 is in a second switching position in which a sample from the sample loop 52 is applied to a chromatography column. In this switching position, the sample loop 52 is switched into the flow path between a liquid reservoir for a first fluid and the connection piece 76. In this switching position of the injection valve 50, a fluid from a first liquid reservoir is introduced into the sample loop 52 via port 56 or port 64 and discharged into the connection piece 76 via port 62 or port 58.

A fluid is passed into the mixer switching valve 82 via line 60 and the connection piece 76, wherein details of the mixer switching valve 82, in particular the connection thereof with the mixer 84 and the bypass loop are described in FIG. 6.

In FIG. 8, the mixer switching valve 82 is in a second switching position in which a fluid or a fluid mixture is passed from the connection piece 76 not into mixer 84, but instead via the bypass loop 98 into a chromatography column.

The configuration shown in FIG. 8 is adopted on application of a sample in order to ensure the mixer 84 is bypassed.

FIG. 9 shows a schematic representation of a portion of a chromatography system, wherein a preferably usable addition unit is in a first switching position and a preferred mixer switching valve is in a first switching position.

The portion shown in FIG. 9 therefore corresponds in many details to that shown in FIGS. 6, 7 and 8, wherein the same reference signs denote identical components, such that the explanations provided in respect of FIGS. 6, 7 and 8 also apply to FIG. 9.

As described in FIG. 6, 7 or 8, the addition unit 48 comprises an injection valve 50 and a sample loop 52, wherein the injection valve 50 comprises six ports (56, 58, 62, 64, 66, 70) which are described in greater detail in FIG. 6.

In FIG. 9, the addition unit 48 is in a second switching position in which a sample from the sample loop 52 is applied to a chromatography column. In this switching position, the sample loop 52 is switched into the flow path between a liquid reservoir for a first fluid and the connection piece 76. In this switching position of the injection valve 50, a fluid from a first liquid reservoir is introduced into the sample loop 52 via port 56 or port 64 and discharged into the connection piece 76 via port 62 or port 58.

A fluid is passed into the mixer switching valve 82 via line 60 and the connection piece 76, wherein details of the mixer switching valve 82, in particular the connection thereof with the mixer 84 and the bypass loop are described in FIG. 6.

In FIG. 9, the mixer switching valve 82 is in a first switching position in which a fluid or a fluid mixture is passed from the connection piece 76 via the mixer 84 into a chromatography column.

The configuration shown in FIG. 9 is adopted once the sample to be applied has passed through the mixer switching valve 82, wherein this position is where possible switched immediately after passage of the sample to be applied. Furthermore, during the actual separation, i.e. after application of the sample, the switching position in FIG. 6 is set, for example in order to introduce a further sample into the sample loop 52.

FIG. 10 is a schematic representation of a chromatography system 100 with a gas-liquid separator 130 which is suitable for supercritical fluid chromatography.

Such a system is described by way of example using supercritical CO₂, wherein methanol is shown as an exemplary solvent. Obviously, systems in which other solvents, preferably organic solvents are applied, or other supercritical fluids are used, have a similar structure.

As shown in FIG. 10, the respective fluids are kept in storage containers, in particular the gas that is still used in a supercritical state is provided in a storage tank 102 and the solvent is provided in a storage tank 104, and they can be conveyed out of the storage tanks 102, 104 to the further components of the system by way of a pump 106, 108 respectively. In the system 100 described here, a preparation stage (110, 112) is preferably provided in each fluid inflow line, by way of which the fluids can be temperature controlled. Further, leveling of the pressure fluctuations indicated by the pumps can also be provided. Accordingly, this preparation stage can be designed, for example, as a heat exchanger or as a pump. An addition unit 114, for example an injector, is provided in the solvent line via which a mixture to be separated is introduced into system 100, before the CO₂ and solvent are introduced into a connection piece 116 and fed to a chromatography column 118. FIGS. 2 and 3 show a preferred embodiment of an addition unit 114. A switchable mixer 117 is provided between the connection piece 116 and the chromatography column 118, which mixer is switchable by way of a mixer switching valve, which is not shown for reasons of clarity, such that the mixer 117 is connectable in a first position and the mixer 117 is bypassable in a second position. FIGS. 4 and 5 show a preferred embodiment of a mixer switching valve, which is connected with a mixer.

In the present system 100, two analysis units are disposed downstream of the chromatography column 118, wherein a sample discharge unit 120 is connected with a mass spectrometer 122 and a UV detector 124 is provided downstream of the sample discharge unit. Downstream of the analysis unit, a device for providing an additional volume 125 is shown in the present case which in particular serves to increase the run time of the liquid so as to be able to evaluate the results, for example, of the mass spectrometer 122. The backpressure regulator 126 provided in the line downstream of the means for providing an additional volume 125 maintains the respective pressure which is required for the fluid to remain in a supercritical state. Downstream of the backpressure regulator 126, a heat exchanger 128 is provided that prevents the aerosol from freezing during the expansion process. Subsequently, the aerosol is introduced into a gas-liquid separator 130 according to the invention, wherein the gas in the system is discharged via an outlet 132.

The liquid is introduced into a fraction collector 134 and fractionated therein. The solvent contained in the fractionated samples can be removed from the samples.

The features of the invention disclosed in the preceding description, as well as in the claims, figures and exemplary embodiments, may be essential both individually and in any combination for realizing the invention in its various embodiments.

1. A chromatography system comprising at least a first pump which is connectable or connected with a liquid reservoir for a first fluid, and a second pump which is connectable or connected with a liquid reservoir for a second fluid, wherein pump outlet lines from the first pump and the second pump are connected with a connection piece and, viewed in a direction of flow, a chromatography column is provided downstream of the connection piece, wherein:
viewed in the direction of flow, an addition unit is provided upstream of the connection piece, and a mixer switching valve and a mixer switchable by way of the mixer switching valve are provided between the connection piece and the chromatography column, wherein the mixer switching valve has at least two switching positions, and wherein the mixer is connectable in a first position and the mixer is bypassable in a second position.

2. The chromatography system according to claim 1, wherein a flow path of a fluid in the second position of the mixer switching valve, in which the mixer is bypassable, is shorter than in the first position of the mixer switching valve, in which the mixer is connectable.

3. The chromatography system according to claim 1, wherein, viewed in the direction of flow, the addition unit is provided downstream of the first pump.

4. The chromatography system according to claim 1, wherein the addition unit comprises an injection valve, wherein the injection valve has at least two sample loop ports and two high-pressure ports for infeed and outfeed of high-pressure fluid.

5. The chromatography system according to claim 1, wherein the mixer switching valve comprises at least four ports, wherein two of said ports are connected with a mixer.

6. The chromatography system according to claim 1, wherein a chromatographic procedure with a solvent gradient is performable.

7. The chromatography system according to claim 1, wherein fluid cooling is provided for the liquid reservoir for a second fluid and the second pump.

8. The chromatography system according to claim 1, wherein the mixer is configured as a static mixer.

9. The chromatography system according to claim 1, wherein the chromatography system is controllable by way of a chromatography system controller.

10. The chromatography system according to claim 1, wherein the chromatography system is configured as a supercritical fluid chromatography (SFC) system, wherein the chromatography system has a chromatography column and, viewed in the direction of flow, at least one downstream backpressure regulator.

11. The chromatography system according to claim 1, wherein, viewed in the direction of flow, a gas-liquid separator is provided downstream of the backpressure regulator.

12. A method for carrying out a chromatographic procedure comprising the use of the chromatography system according to claim 1.

13. The method according to claim 12, wherein the liquid reservoir for a first fluid contains a first solvent which is liquid under standard conditions, and the liquid reservoir for a second fluid contains a second solvent which is gaseous under standard conditions.

14. The method according to claim 12, wherein, on application of a sample to be separated to the chromatography column, the mixer switching valve is switched into the second position and the fluid is bypassed around the mixer.

15. A conversion kit for converting a high-performance liquid-chromatography (HPLC) system into a chromatography system according to claim 1, wherein the kit includes at least one gas-liquid separator and at least one mixer switching valve.
